(19) United States
(12) Patent Application Publication
(10) Pub. No.: US 2024/0213696 A1
(43) Pub. Date: Jun. 27, 2024

(54) HIGH CURRENT LOW INDUCTANCE COMPLIANT INTERCONNECT SYSTEM

(71) Applicant: Raytheon Company, Waltham, MA (US)

(72) Inventors: Troy Tharp, Richardson, TX (US); Ian E. Nord, McKinney, TX (US); Joseph P. Nipper, Allen, TX (US); Cody Brandon Lima, Richardson, TX (US)

(73) Assignee: Raytheon Company, Waltham, MA (US)

(21) Appl. No.: 18/145,337

(22) Filed: Dec. 22, 2022

(51) Int. Cl. H01R 12/70; H01R 12/71; H01R 24/50; H01R 24/54

(52) U.S. Cl. CPC H01R 12/7082; H01R 12/716; H01R 24/50; H01R 24/542

(57) ABSTRACT

An interconnect including a first connector, a second connector, and a bullet connector. The first connector includes a first conductive, compliant conductive center pin and a first shroud. The second connector includes a second conductive, compliant center pin and a second shroud. The bullet includes first and second ends that couple, respectively, to the first and second connectors, an inner conductor, an outer conductor, and an electrically insulator layer disposed therebetween. The inner conductor includes a first compliant jack at the first end that is electrically coupled to a second compliant jack at the second end. Each compliant jack includes a plurality of center pin spring fingers configured to engage the respective compliant center pin of the respective first or second connector. The other conductor includes respective pluralities of body spring fingers at each end that are configured to engage, respectively, with the first and second shrouds.

### FIELD

Embodiments of the disclosure generally relate to devices, systems, and methods for providing interconnections between electrical components, especially circuit boards. More particularly, the disclosure describes embodiments relating to devices, systems, and methods for high current, low current, compliant interconnect devices.

### BACKGROUND

An electronic assembly may have a number of electrical connectors that electrically (and mechanically) couple to another electronic assembly or system, such as connectors that interconnect between circuit boards. Sometimes it is desirable to transfer signals (e.g., power signals) from one circuit board to another circuit board. Many different types of electrical connectors are used to transmit electrical signals and/or power within a circuit and/or between a circuit and another circuit or device. Multiple ways exist to connect and disconnect connectors at a connection interface, including but not limited to hard wiring (e.g., soldering), push on connection, twist on connections, screw on connections, etc. Electrical connectors can be classified into three broad types based on their termination ends: board-to-board connectors, cable/wire-to-cable/wire connectors, and cable/wire-to-board connectors. Board-to-board connectors, for example, may be used to connect printed circuit boards (PCBs) without the usage of a wire. Board-to-board connectors are also useful for systems with limited space because they can reduce wire clutter.

### SUMMARY

The following presents a simplified summary in order to provide a basic understanding of one or more aspects of the embodiments described herein. This summary is not an extensive overview of all of the possible embodiments and is neither intended to identify key or critical elements of the embodiments, nor to delineate the scope thereof. Rather, the primary purpose of the summary is to present some concepts of the embodiments described herein in a simplified form as a prelude to the more detailed description that is presented later.

In some board-to-board connectors, male and female interfaces can be engaged and disengaged to connect and disconnect the electrical signals and/or power. These interfaces may use socket contacts that are designed to engage pin contacts, e.g., metallic contacts, which may be surrounded by an insulator (e.g., plastic, TEFLON, etc.) having dielectric characteristics. A metallic housing surrounds the insulator to provide electrical grounding and isolation from electrical interference or noise. These connector assemblies can be coupled by various methods including a push-on design, as well as designs that make use of full or limited detents, as will be understood.

In radiofrequency and other applications requiring impedance matching, the resulting connector may be configured to have a specific electrical impedance (e.g., 50Ω), such as by specific configurations of the insulator location and/or the insulator material properties, as is understood. In applications where the signal being carried is not as dependent on impedance matching (such as applications where the conductor is carrying direct current (DC) signals), impedance matching is less important, and there is more flexibility in configuring the parts of the connector.

Various configurations exist for push on board-to-board connectors. For example, a push on board-to-board connector configuration can be a two piece system (male to female) or a three piece system (male to female-female to male). The three piece connector system, in some arrangements, uses a double ended female interface known as a blindmate interconnect (BMI). An exemplary BMI includes a double ended socket contact, two or more insulators, and a metallic housing with grounding fingers. Use of BMI's is advantageous if access to the connection point is challenging, such as when there are physical space constraints. Thus, an advantageous application for BMI's is mating together two PCBs. In addition, BMIs can be advantageous in harsh environments, such as military applications, where electronic components not only have to fit into tight spaces having limited ability to access, but also have to be subject to temperature, shock, and vibrational extremes during operation. BMIs also are advantageous in less harsh environments and in commercial products, especially as PCBs have become more complex and denser.

The three piece connector system also makes use of two male interfaces (e.g., one coupled to each respective PCB to be connected) each with a pin contact, insulator, and metallic housing (“shroud”). For example, the male interfaces may be coupled to respective PCBs that are being interconnected. The insulator of the male interface can be a material such as plastic or glass. In some examples, a shroud on a male interface may have a detent feature that engages front fingers of the BMI metallic housing for mated retention. As is understood in the art, the detent feature can be modified thus resulting in high and low retention forces for various applications. Detent types of features also may be provided as part of the BMI. In some arrangements, the three piece connector system enables improved electrical and mechanical performance during radial and axial misalignment.

In addition, in many applications, the area/space on or around electronics assemblies is limited and valuable. Thus, low-profile electrical and mechanical connections between such assemblies is desired, such as with RF and/or power connectors. In addition, tolerance issues can cause misalignment between a pair of electronic assemblies, which can pose various problems when electrically and mechanically coupling the assemblies together. It is advantageous if connectors and interconnections between electronics assemblies, such as PCBs, are able to withstand some misalignment or other tolerance issues.

One general aspect includes an interconnect, comprising a first connector, a second connector, and a bullet connector. The first connector comprises a first compliant center pin and a first shroud, wherein the first compliant center pin comprises an electrically conductive material and wherein the first shroud is configured with a first connector detent feature. The second connector comprises a second compliant center pin and a second shroud, wherein the second compliant center pin comprises an electrically conductive material and wherein the second shroud is configured with a smooth bore feature. The bullet connector is configured to be electrically and mechanically coupled to the first and second connectors, the bullet connector comprising a first end, second end, inner conductor, insulator layer, and outer conductor. The inner conductor further comprises a first compliant jack disposed proximate to the first end and electrically coupled to a second compliant jack disposed proximate to the second end. The first compliant jack comprises a plurality of first center pin spring fingers configured to engage the first compliant center pin. The second compliant jack comprises a plurality of second center pin spring fingers configured to engage the second compliant center pin. The outer conductor is spaced apart from the inner conductor by a predetermined gap and is configured to engage electrically and mechanically with the first and second shrouds, wherein the outer conductor extends from the first end to the second end, wherein a first section of the outer conductor that is proximate to the first end, is formed from a plurality of first body spring fingers and wherein a second section of the outer conductor that is proximate to the second end is formed from a plurality of second body spring fingers. The plurality of first body spring fingers and the plurality of second body spring fingers are configured to engage, respectively, with the first shroud and the second shrouds. The insulator layer comprises an electrically insulating material disposed in between the inner conductor and the outer conductor and is configured to electrically isolate the inner conductor from the outer conductor, wherein the insulator layer is configured to be concentric with the inner conductor and outer conductor.

Implementations may include one or more of the following features. The interconnect is configured wherein the predetermined gap between the inner conductor and outer conductor has a size selected to minimize an inductance of the interconnect. The inner conductor and outer conductor each have a size suitable for carrying high levels of direct current (DC). A size of at least one of the first compliant jack and second compliant jack is selected to maximize allowable misalignment. At least one spring finger of the plurality of first center pin spring fingers of the first compliant jack and the plurality of second center pin spring fingers of the second compliant jack, is configured to deflect to maintain electrical connection to a respective compliant center pin inserted into a respective compliant jack, under a condition where the first connector is not aligned to the second connector. The at least one spring finger that is configured to deflect, deflects by an amount that is less than a diameter of the compliant center pin inserted within the respective compliant jack, wherein an amount of the deflection of the at least one spring finger is configured to enable retention of at least a majority of a set of points of contact between the spring fingers and the compliant center pin. At least one of the plurality of first body spring fingers and second body spring fingers, is configured to deflect, when a respective compliant center pin is inserted into a respective compliant jack, to maintain electrical connection to the respective shroud of the respective first or second connector whose compliant center pin is inserted into the respective compliant jack. At least one of the first and second compliant center pins is configured to compensate for at least one of radial and axial misalignment between the first connector and the second connector, when the first connector and second connector are operably coupled to the bullet connector. The plurality of first body spring fingers are configured to form a spring finger detent feature configured to engage with the first connector detent feature. An interface between the spring finger detent feature and the first connector detent feature is configured to allow a predetermined amount of radial misalignment between the first connector and the bullet connector, while still ensuring that the spring finger detent feature is engaged with the first connector detent feature. The plurality of second body spring fingers are configured to engage with the smooth bore feature. An interface between the plurality of second body spring fingers and the smooth bore detent feature is configured to allow a predetermined amount of at least one of axial and radial misalignment between the second connector and the bullet connector, while still ensuring that the plurality of second body spring fingers is engaged with the smooth bore feature.

One general aspect includes a bullet connector configured to interconnect first and second connectors. The bullet connector comprises a first end, a second end, an inner conductor, an outer conductor, and an insulator layer. The first end comprises a first compliant jack configured for engaging a first center pin of a first connector, wherein the first compliant jack comprises a plurality of first center pin spring fingers configured to engage the first center pin. The second end comprises a second compliant jack and is configured for engaging a second center pin of a second connector, wherein the second compliant jack comprises a plurality of second center pin spring fingers configured to engage the second center pin. The inner conductor is configured to electrically couple the first compliant jack to the second compliant jack. The outer conductor is spaced apart from the inner conductor by a predetermined gap and configured to engage electrically and mechanically with a first shroud of the first connector and a second shroud of the second connector. The outer conductor extends from the first end to the second end, wherein a first section of the outer conductor that is proximate to the first end, is formed from a plurality of first body spring fingers and wherein a second section of the outer conductor that is proximate to the second end is formed from a plurality of second body spring fingers. The plurality of first body spring fingers and the plurality of second body spring fingers are configured to engage, respectively, with the first shroud and the second shroud. The insulator layer comprises an electrically insulating material disposed in between the inner conductor and outer conductor and is configured to electrically isolate the inner conductor from the outer conductor, wherein the insulator layer is configured to be concentric with the inner conductor and outer conductor.

Implementations may include one or more of the following features. The predetermined gap between the inner conductor and outer conductor has a size selected to minimize an inductance of the bullet connector. A size of at least one of the first and second compliant jacks is selected to maximize allowable misalignment. The inner conductor and outer conductor each have a size suitable for carrying high levels of direct current (DC). At least one spring finger of the plurality of first center pin spring fingers of the first compliant jack and the plurality of second center pin spring fingers of the second compliant jack, is configured to deflect to maintain electrical connection to a respective compliant center pin inserted into the respective compliant jack, under a condition where the first connector is not aligned to the second connector. The at least one spring finger that is configured to deflect, deflects by an amount that is less than a diameter of a center pin inserted within the respective compliant jack, wherein an amount of the deflection of the at least one spring finger is configured to enable retention of at least a majority of a set of points of contact between the spring fingers and the center pin. At least one of the plurality of first body spring fingers and second body spring fingers, is configured to deflect, when a center pin is inserted into the respective compliant jack, to maintain electrical connection to a respective shroud of a connector whose center pin is inserted into the respective compliant jack.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the claims included herein.

Details relating to these and other embodiments are described more fully herein.

### BRIEF DESCRIPTION OF THE DRAWINGS

The advantages and aspects of the described embodiments, as well as the embodiments themselves, will be more fully understood in conjunction with the following detailed description and accompanying drawings, in which:

FIG. 1A is a first cross-section view showing an exemplary implementation of an embodiment of a plurality of interconnects within a system that is operably coupling together two circuit card assemblies (CCAs), in accordance with one embodiment;

FIG. 1B is an exploded view showing an illustration of an exemplary environment where the interconnect of FIG. 1A and of any of FIGS. 2-12, could be implemented, in accordance with one embodiment;

FIG. 2 is a second cross-section view showing an exploded view of an implementation that incorporates an interconnect, in accordance with one embodiment;

FIG. 3 is a third cross section view showing an exploded view of the interconnect of FIG. 2 in a partially connected arrangement, in accordance with one embodiment;

FIG. 4 is fourth cross section view showing the interconnect of FIG. 2 in a fully connected arrangement, in accordance with one embodiment;

FIG. 5 is a fifth cross section view, showing the further details of the interconnect of FIG. 2, in the fully connected arrangement of FIG. 4, in accordance with one embodiment;

FIG. 6 is a side view of a bullet connector of the interconnect of FIG. 3, in accordance with one embodiment;

FIG. 7 is a perspective view of the bullet connector of FIG. 6, showing some details of a first end of the bullet connector, in accordance with one embodiment;

FIG. 8 is a side perspective view of the bullet connector of the interconnect of FIG. 6, showing some details of a second end of the bullet connector, in accordance with one embodiment;

FIG. 9 is a view from the first end of the bullet connector of FIG. 6, in accordance with one embodiment;

FIG. 10 is a cross section view of an example interconnect similar to that of FIGS. 2-9, showing further details of the structure and directions of current flow, in accordance with one embodiment;

FIG. 11 is a cross section view showing further details of one region in the cross-section view of FIG. 10, in accordance with one embodiment; and

FIG. 12 is a cross section view showing an illustration of how the interconnect of any of FIGS. 1-12 continues to maintain operable electrical contacts during misalignment, in accordance with one embodiment.

The drawings are not to scale, emphasis instead being on illustrating the principles and features of the disclosed embodiments. In addition, in the drawings, like reference numbers indicate like elements.

### DETAILED DESCRIPTION

Before describing in detail the particular improved systems, devices, and methods, it should be observed that the concepts disclosed herein include, but are not limited to, one or more novel processes, one or more novel structural combination of components and circuits, and one or more novel systems, and are not necessarily limited solely to the particular detailed configurations thereof. Accordingly, the structure, methods, functions, control and arrangement of process steps, elements, components and/or circuits have, for the most part, been illustrated in the drawings by readily understandable and simplified block representations and schematic diagrams, in order not to obscure the disclosure with structural details which will be readily apparent to those skilled in the art having the benefit of the description herein. In particular, it should be noted that figures herein are not necessarily drawn to scale, even when dimensions are shown, so that particular details and features may be more clearly illustrated and described.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context, as will be understood.

Sometimes it is desirable to transfer signals (e.g., power signals, digital signals and so forth) from one circuit board to another circuit board, where the circuit cards are stacked, for example. The circuit cards may be stacked in a parallel or substantially parallel configuration to one another. As described herein, various examples of electrical connectors may be used to mate two circuit cards, for example, two circuit cards that are stacked together. As described herein, the term “stacked” means that the two circuit cards are spaced apart. As will be shown, when the two circuit cards are electrically connected, an electrical connector can be disposed between the two circuit cards, to interconnect the two cards. In one particular example, the two circuit cards are parallel or substantially parallel. The electrical connectors and interconnects that are discussed herein may be used in any environment where electrical connectors are used to electrically connects circuit cards together, especially environments where high current must be moved between boards or assemblies in a CCA stack up, in a limited volume.

In situations where cabling cannot be used due to mechanical packaging, electrical, cable length or other restrictions, other methods are required. In other situations, the connections between two circuit cards may be required to meet certain tolerance requirements. In some configurations, there is a need to transmit current between two boards with multiple power forms physically spread across one or both of the boards, a need for the power transmitted to have a low inductance, and a need for the connection to be made in a physically constrained area with limited tooling access. In some configurations, there is a need to provide interconnects that can work with misalignments that can occur in the x, y, and/or z direction. To help address these and other issues, a high current, low inductance, compliant interconnect is needed.

Attempts have been made to provide the most optimum type of a high current, low inductance, compliant interconnect. For example, rectangular connectors were investigated, but mechanical alignment of multiple connectors was difficult to implement, and inductance was unacceptable. Various types of commercially available bullet connectors were investigated, but either the current capability was too low, or the inductance was too high. Bus bars were also considered but were found to pose a significant installation challenge in physically constrained areas. Wired lugs were also investigated, but the lugs could not maintain the necessary inductance for the application's requirement. With the three desired characteristics of having low inductance, having high current, and being compliant (e.g., tolerant of some misalignment), some solutions might provide two of the desired characteristics, but not all three.

In one embodiment, a solution was developed to create a three piece interconnect system having a blindmate bullet type connector configured to be operably coupled to mating first and second connectors that are configured to be connected to circuit card assemblies. As discussed and described further herein, the interconnect is configured to have spring fingers on either or both ends, to help allow for a large amount of axial and radial misalignment while still ensuring electrical connections and providing a low resistance interconnect system.

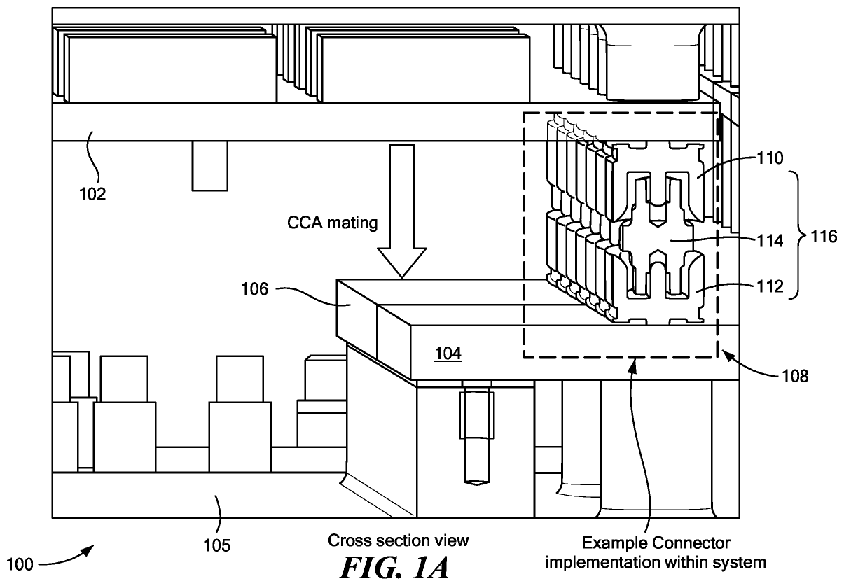

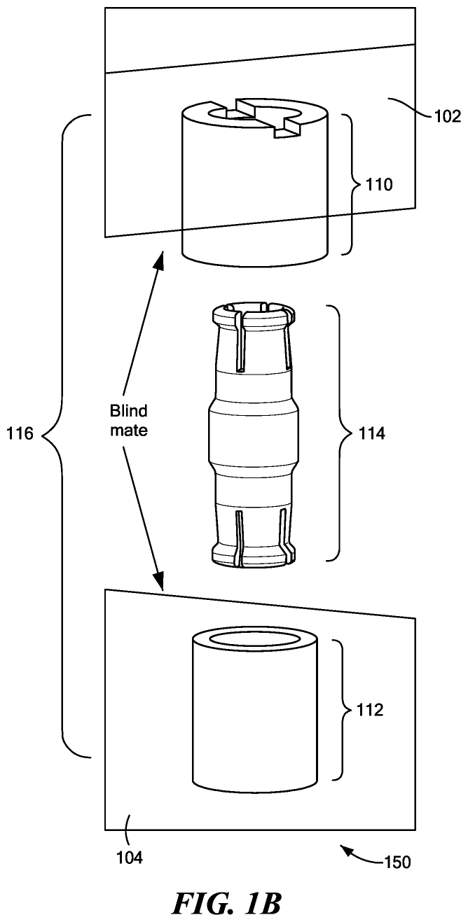

For example, FIG. 1A is a first cross-section view 100 showing an exemplary implementation of a plurality of the above-described three piece interconnect 116, within a system, wherein the plurality of interconnects 116 are shown within the dashed region 108. The plurality of interconnects 116 are operably coupling together one or more of a first circuit card assembly (CCA) 104, to one or more of a second CCA 102, in accordance with one embodiment. In addition, note that the exemplary embodiment of FIG. 1A depicts a third CCA 106 adjacent to the first CCA 104, where the plurality of interconnects 116 also couples the third CCA 106 to the second CCA 102, as will be understood. In some embodiments, the first CCA 104 and second CCA 102 may be connected to other system elements, such as the cold plate 105 in operable communication with first CCA 104. Each interconnect 116, in this embodiment, has three pieces: a first CCA connector 112, a power bullet 114 (also referred to herein as “bullet connector 114”), and a second CCA connector 110. The first CCA connector 112 and second CCA connector 110 are shown herein, for illustrative purposes, to be through hole types of connectors, but this is not limiting. The region 108 depicts a plurality of interconnects 116, but a given implementation need not include multiple interconnects 116, as will be appreciated.

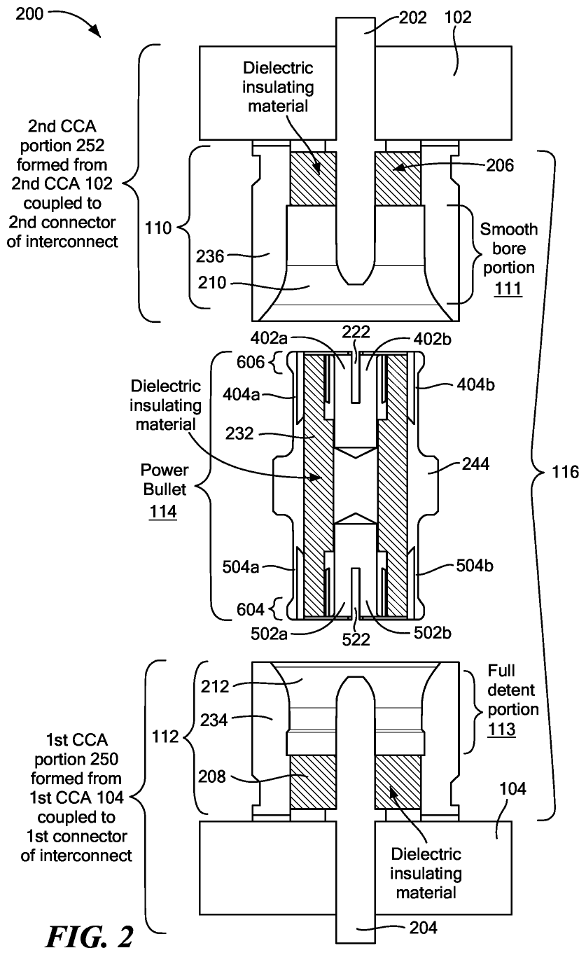

FIG. 1B is an exploded view 150 showing an exemplary illustration of an environment where the interconnect of FIG. 1 and of any of FIGS. 2-12, could be implemented, in accordance with one embodiment. FIG. 1B shows that a power bullet 114 can be coupled in a blindmate fashion in between a first CCA connector 112, mounted to a first circuit card assembly (CCA) 104, and a second CCA connector 110, mounted to a second CCA 102. The details of each of these parts of the interconnect 116 are discussed further herein.

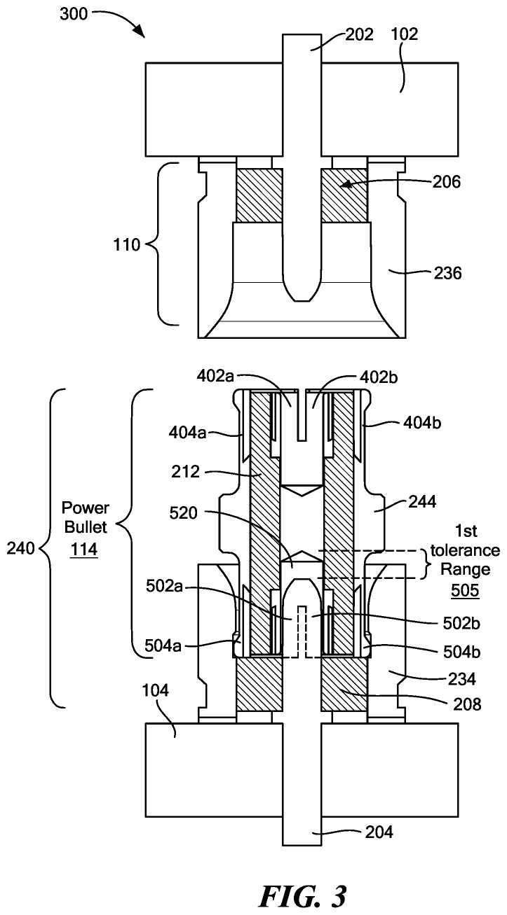

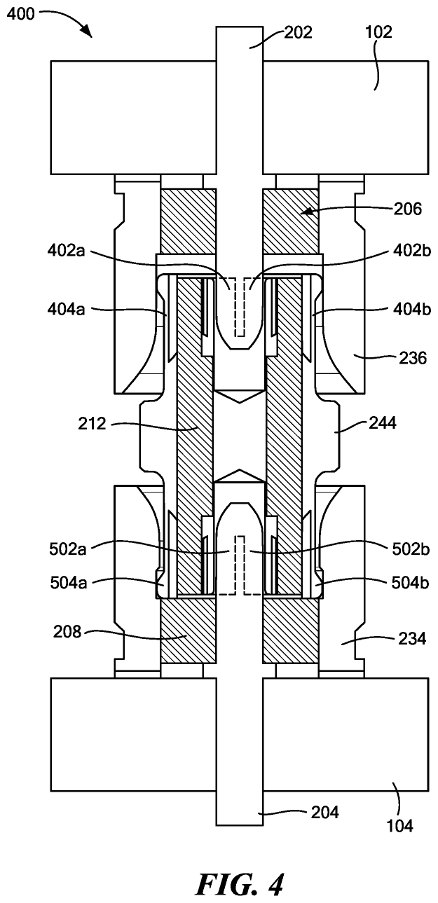

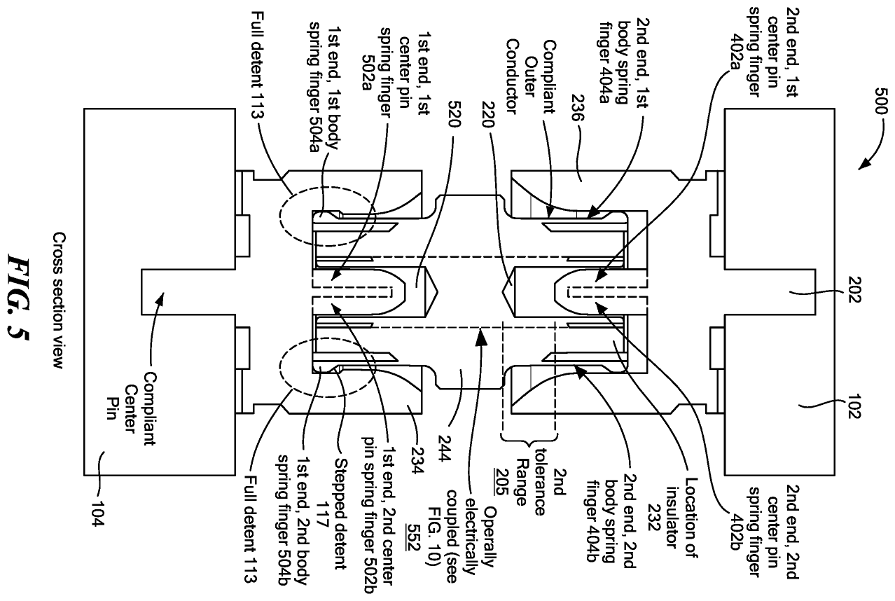

FIGS. 2-4 are cross section views showing one of the interconnects 116 of FIG. 1A, in greater detail as it is assembled together, and FIG. 5 provides further details on the fully assembled interconnect 116. In particular, FIG. 2 is a second cross-section view 200 showing an exploded view of one of the interconnects 116 of FIGS. 1A and 1B, in greater detail, in accordance with one embodiment. FIG. 3 is a third cross section view 300 showing an exploded view of the interconnect of FIG. 2 in a partially connected arrangement, in accordance with one embodiment. FIG. 4 is fourth cross section view 400 showing the interconnect of FIG. 2 in a fully connected arrangement, in accordance with one embodiment. FIG. 5 is a fifth cross section view, showing the further details of the interconnect of FIG. 2, in the fully connected arrangement of FIG. 4, in accordance with one embodiment.

Referring now to FIGS. 2-5, the interconnect 116 of FIGS. 2-5, like that of FIGS. 1A and 1B, includes a first CCA connector 112, a power bullet 114, and a second CCA connector 110. The first CCA connector 112 is operably coupled to the first CCA 104, to form a first CCA portion 250. The second CCA connector 110 is operably coupled to the second CCA 102, to form a second CCA portion 252. The second CCA connector 110 and first CCA connector 112 each include a respective center pins 202. 204 that is formed from an electrically conductive material, such as gold, silver, copper, and alloys thereof. In certain embodiments, the respective center pin 202, 204 is a compliant center pin, meaning that the center pin is able to be displaced or bent, when a load is applied. For example, in some embodiments, one or both of the center pins 202, 204 are implemented using so-called “press fit” pins, which are compliant pins featuring an elastic behavior that deforms during insertion. In certain embodiments, compliance is provided by the first end center pin spring fingers 502a, 502b and the individual second end center pin spring fingers 402a, 402b, but this is not limiting.

In certain embodiments, one or both of the first center pin 204 and second center pin 202 are advantageously formed using a solid piece of copper having a size proportional to the current being carried. Electrically conductive plating metals—like aluminum, gold, silver, or tin—may be used with copper to alter the performance characteristics of the center pins 202, 204. The diameters of each of the first center pin 204 and second center pin 202, in certain embodiments, are selected to meet derated current carrying capacity requirements of the application.

In certain embodiments, depending on the application, to increase flexibility of the center pins 202, 204 and if current carrying capacity is sufficient, the center pins 202, 204 can be formed using a braided or stranded portion of electrically conductive material. For the example CCA connectors 110, 112, the respective center pins 202, 204 are configured to be a through hole type, and the outer conductor (i.e., the shrouds 236, 234) are configured to be surface mount, but this is not limiting.

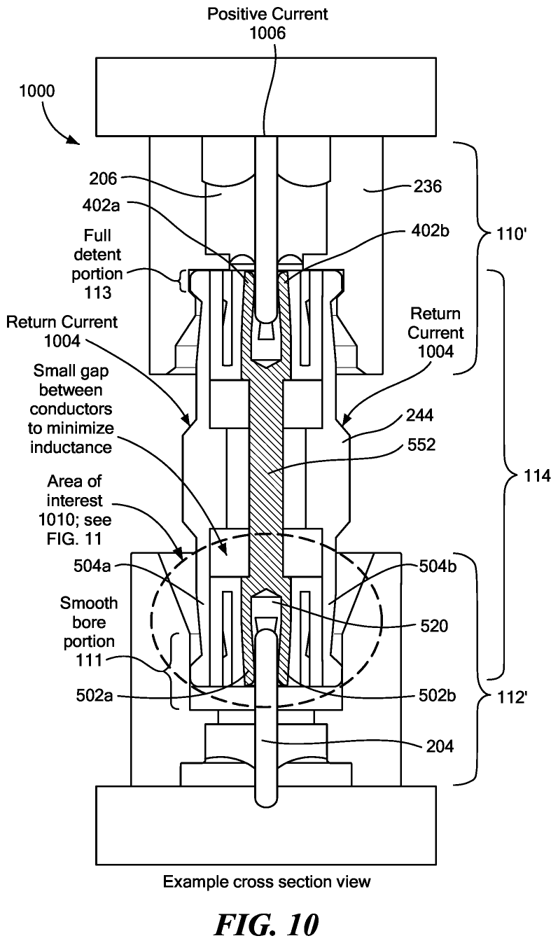

Each respective CCA connector 110, 112 also includes a respective portion corresponding to a shroud 236, 234 (which also may be known in the art as a housing, casing, or shell, as will be understood). The shrouds 236, 234 may be formed of any material suitable for the application, including but not limited to stainless steel (e.g., passivated stainless steel), brass, aluminum, beryllium copper, gold plate over nickel plate, etc. The shrouds 236, 234 are electrically insulated from the respective first center pin 204 and second center pin 202 by respective first insulator 208 and second insulator 206, as shown in FIGS. 2-5. Each respective insulator 206, 208 is made from a dielectric material that is electrically insulating and is configured to insulate the respective center pins 202, 204 from the respective shroud 236, 234. For example, in some embodiments, the dielectric material comprises an insulating material such various types of plastics (e.g., plastic polytetrafluoroethylene (PTFE), e.g., TEFLON, polycarbonate, etc.), polyethylene (PE), polypropylene (PP), fluorinated ethylene propylene (FEP)glass, rubber, ceramic, quartz, etc., but this is not limiting. As is understood, the dielectric material is used to provide physical separation and electrical insulation between the inner conductor (e.g., the first jack 520 (FIG. 5), second jack 220 (FIG. 5), and center conductor electrical connection 552 (FIGS. 5, 10 &11)) and the outer conductor 244 (shell 244) or a shield (shell 244 is also referred to herein as outer conductor 244 (FIGS. 2-12)). The insulator material used advantageously has stable electrical characteristics (dielectric constant and dissipation factor) across a frequency and power range of interest. Polytetrafluoroethylene (PTFE, such as TEFLON) is a dielectric material used in many connector applications. The optimum material used may depend on the application, as is understood. For example, polyethylene (PE) and polypropylene (PP) are common in applications that have lower cost, power and temperature range requirements, whereas other materials, such as FEP (fluorinated ethylene propylene) and PTFE, although more costly, can be more advantageous for high power and temperature range applications, with more resistance to environmental variations.

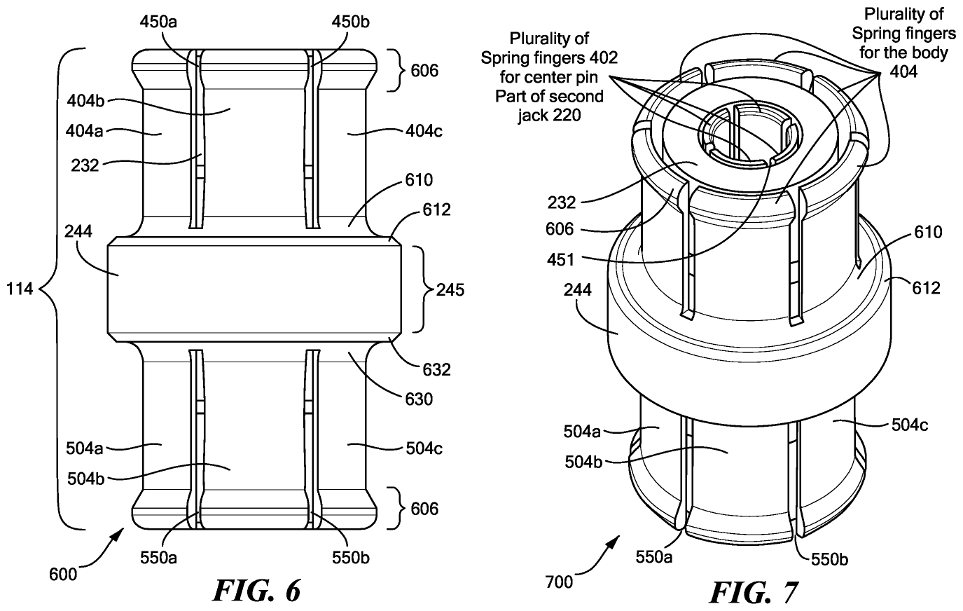

The first CCA connector 112 is substantially similar to the second CCA connector 110, except that the first CCA connector 112 is configured as a full detent type of connector and thus includes a full detent portion 113, whereas the second CCA connector 110 is configured as a smooth bore type of connector includes a “smooth bore” portion 111. Details on the full detent portion are also shown in greater detail in FIG. 5. The full detent portion 113, in certain embodiments, is configured to mate at least partially to either of the first locking edge 604 (FIGS. 2 & 7) or second locking edge 606 (FIGS. 2, 6-7) on the power bullet 114 (described further in connection with FIGS. 6-7 herein). Using a smooth bore connector on one PCB, a bullet connector, and a full detent (or limited detent) connector on the opposite PCB, helps to ensure that the bullet connector remains mated to the connector with the full or limited detent portion. In certain embodiments, the smooth bore portion 111 further can be configured with a flared entry to provide a so-called “catcher's mitt” feature that provides a wide guide-in range to enable more tolerance to slight misalignments.

As those of skill in the art understand, in module to module and board to board applications, a system comprising three connectors can be used to help facilitate connection, especially if one of the connectors is configured to help hold in the blindmate connector during assembly. For example, in a three-connector system as shown in FIGS. 2-5, a the blindmate interconnect corresponds to the power bullet 114, which is configured to mate between a first connector (e.g., first CCA connector 112 of FIGS. 2-5) having the respective shroud 234 that includes a full detent portion 113 and the second CCA connector 110 of FIGS. 2-5, having the second respective shroud 236 that includes a smooth bore portion 111. As noted above, the full detent portion 113 helps to retain the power bullet 114 in a mated position during assembly (e.g., as shown in the partially assembled view of FIG. 3), so that the first CCA portion 250 can be mated to the second CCA portion 252 as shown in FIG. 4 and FIG. 5. In some embodiments, a full detent feature may be configured to have different engage and disengage coupling forces as compared to a limited detent feature. For example, in some arrangements a limited detent feature is advantageous for snap on interface applications for PCB mounts and blind mating, and a full detent may be more advantageously used with cabled connections where higher retention forces are required.

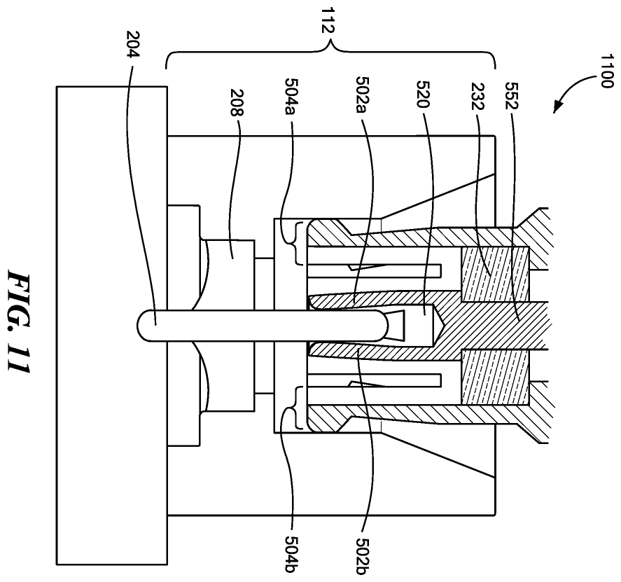

Referring still to FIGS. 2-5, the power bullet 114 includes a first jack 520 and a second jack 220, which are configured to serve as a socket or receptacle that is configured to couple, respectively, to the first center pin 204 and second center pin 202, to provide an electrical connection 552 from the first end of the power bullet 114 to the second end of the power bullet 114, as will be understood. The first jack 520 and second jack 220 are operably electrically connected together via the electrical connection 552, although this electrical connection 552 is not explicitly visible in FIG. 5 (is shown via dashed lines). The second end center first spring finger 402a and second end center pin second spring finger 402b are compliant on either side and further help to provide electrical contact (the same applies to the first end center pin spring fingers 502a, 502b, as will be understood). To better see an illustration of the electrical connection between the first jack 520 and the second jack 220, reference is made briefly to FIG. 10, which is a cross section view 1000 of an example interconnect similar to that of FIGS. 2-5, showing further details of the structure and directions of current flow, in accordance with one embodiment as well as to FIG. 11, which is a cross section view 1100 showing further details of one region 1010 in the cross section view 1000 of FIG. 10, in accordance with one embodiment.

As FIGS. 10-11 illustrate, the first jack 520 and second jack 220 are part of a continuous, electrically-conductive electrical connection 552. FIGS. 10-11 also illustrate that the first jack 520 includes a plurality of first end center pin spring fingers 502 that are configured to form a compliant interface that is configured to deflect to grip a center pin (e.g., first center pin 204). Note that the cross-sectional views of FIGS. 10-11 only depict individual first end center pin spring fingers 502a, 502b and individual second end center pin spring fingers 402a, 402b, that are visible in the respective cross-sectional views, but those of skill in the art will appreciate that the plurality of first end center pin spring fingers 502 and the plurality of second end center pin spring fingers 402 each may include more than just the individual respective visible center pin spring fingers that are shown. Similarly, the cross-sectional views of FIGS. 10-11 depict individual first end body spring fingers 504a, 504b and individual second end body spring fingers 404a, 404b, but those of skill in the art will appreciated that the plurality of first end body spring fingers 504 and the plurality of second end body spring fingers 404 each may include more than just the respective body spring fingers that are visible in FIGS. 10-11. In certain embodiments, the pluralities of center pin spring fingers 502, 402 herein (as well as the pluralities of body spring fingers 404, 504 herein) are formed as cantilevered beams capable of deflecting, as is understood. In certain embodiments, the center pins (e.g., first center pin 204 and second center pin 202) are compliant as well. In certain embodiments, the deflection of the pluralities of center pin spring fingers 502, 402 happens when the power bullet 114 is coupled to a CCA connector, wherein the contact of the pluralities of body spring fingers 504, 404 with the respective CCA connectors 110, 112 causes the pluralities of body spring fingers 504, 404 to deform slightly inward, and the pluralities of center pin spring fingers 502, 402 grip the center pins 202, 204, respectively, via a cantilevered effect, such that the pluralities of center pin spring fingers 402, 502, of the respective jack 520, 420, firmly grip the respective center pins 204, 202 that have been inserted into the respective jack 520, 220. Similarly, FIGS. 10-11 also illustrate that the second jack 220 includes a plurality of second end center pin spring fingers 402 that are configured to deflect (e.g., as more readily viewed in FIGS. 10-12 and as discussed above) to grip a center pin (e.g., second center pin 202). The pluralities of center pin spring fingers 502, 402, help to firmly grip or minimize contact resistance across the interface, where the cantilevered springiness of the pluralities of center pin spring fingers 502, 402 help to keep them in contact with the respective center pins 202, 204, through misalignments. This is discussed further herein.

The third dielectric layer 232 is disposed in between the inner conductor and outer conductor of the power bullet 114. In certain embodiments, the third dielectric layer 232 is made of materials such as one or more of the dielectric materials listed above for the CCA connectors 110, 112. The outer shell 244 of the power bullet 114 serves as an outer conductor and is configured to carry return current. The outer shell 244 of the power bullet 114 includes a first end (shown in FIGS. 2-5 as the “bottom” end of the power bullet 114) having a plurality of first end body spring fingers 504. For clarity of illustration in the cross section views of FIGS. 2-5, only a first end, first body spring finger 504a and a first end, second body spring finger 504b, are shown, but it will be appreciated that the pluralities of body spring fingers at each end are intended to go all around the periphery of each CCA connector, as illustrated FIGS. 6-9, discussed further below. The third dielectric layer 232 runs from one end of the power bullet 114 to the other and is configured to be concentric to the first and second jacks 520, 220, respectively, as well as to the plurality of first end body spring fingers 504 and the plurality of second end body spring fingers 404.

The plurality of first end body spring fingers 504 is configured to make electrical and mechanical contact with the shroud 234 of first CCA connector 112. As shown more particularly in FIG. 5, in certain embodiments, the plurality of first end body spring fingers 504 engages with a full detent feature of full detent portion 113 formed as part of the shroud 234 of the first CCA connector 112. At the second end of the power bullet 114 (shown in FIGS. 2-5 as the “top” end), the plurality of second end body spring fingers 404 engages with a smooth bore portion 111 of second CCA connector 110, where the engagement has lower mating forces than the full detent feature of full detent portion 113. As can be seen further in FIG. 5, the second shroud 236 of second CCA connector 110 does not have the stepped detent 117 of the full detent feature of full detent portion 113.

In certain embodiments, the outer shell 244 portion of the power bullet 114 (i.e., the part that includes the plurality of first end body spring fingers 504 and the plurality of second end body spring fingers 404, as well as the aforementioned first and second locking edges 604, 606, respectively) is made from an electrically conductive material, such as beryllium copper (or other conductive material), copper, copper-coated aluminum, etc., which advantageously has been heat treated and gold plated, but this is not limiting. Similarly, in certain embodiments, the first jack 520, second jack 220, and electrical connection 552, of the power bullet 114, in certain embodiments, also are made from electrically conductive material, such as beryllium copper (or other conductive material), copper, copper-coated aluminum, etc., which advantageously has been heat treated and gold plated, but this is not limiting. The diameters/thickness of the outer shell 244, the pluralities of body spring fingers 504, 404, the pluralities of center pin spring fingers 502, 402, the first jack 520, the second jack 220, etc., all can be selected, based on a given application, to meet a derated current carrying requirements.

Referring still to FIGS. 2-5 and 11-12, in certain embodiments, the first jack 520 and second jack 220 are configured to carry positive current and are isolated from the outer shell 244 of the power bullet 114 by the aforementioned third dielectric layer 232. FIG. 7, discussed further herein, also illustrates this isolation. The outer shell 244, in certain embodiments, serves as an outer conductor. Positive current can be carried on either the inner conductor portion (i.e., first jack 520, second jack 220, and electrical connection 552) or the outer conductor (i.e., outer shell 344, including the plurality of first end body spring fingers 504 and the plurality of second end body spring fingers 502), and the return current may be carried on the other conductor while minimizing loop area between the inner and outer conductors for low inductance. In particular, by reducing the size of the gap between the inner conductor portion and the outer conductor portion, inductance for DC power transmission can be reduced. In certain embodiments, by sizing the center conductor of the interconnect 116 (i.e., the combination of the first center pin 204, first jack 520, electrical connection 552, second jack 220, and second center pin 202) such that the current carrying capacity can be increased, the gap between the supply and return path is decreased, reducing the inductance of the interconnect 116 and making the design suitable for power transmission. In certain embodiments, this center conductor optimization is done to minimize inductance while maximizing allowable misalignment. As center conductor size increases to reduce inductance, available compliance decreases, thus reducing the capacity to account for misalignment. As will be appreciated, there is a trade-off between minimizing inductance and maximizing allowable misalignment, such that one cannot minimize inductance and maximize allowable misalignment at the same time.

Minimizing the gap between supply and return paths helps to minimize inductance in situations where frequency and impedance matching is not a concern. For example, assume a given length of a connector or a cable having an inner conductor of radius of d meters (m) and an outer conductor having a radius of D meters (assume outer conductor is concentric with inner conductor) are configured to be separated by a material having a constant permeability μ in Henries (H). At lower frequencies, the inductance of the connector or cable is proportional to the length of the connector or cable and does not depend on the dielectric constant of the material between the conductors. The inductance can be calculated by the following formula that. The inductance for the given length (assume 1 meter), in nH/m, can be computed as:

$$L = \frac{µ}{2 π} {log}_{10} \frac{D}{d} \qquad ( 1 )$$

Assume for simplicity that the permeability μ=1. Thus, (1) simplifies to:

$$L = 0 \text{.159} \times {log}_{10} \frac{D}{d} \qquad ( 2 )$$

If permeability was some other number (other than the number of 1 assumed here), it would still result in a constant multiplied by the logarithm of the ratio of outer diameter to inner diameter. Equation (1) shows that, assuming any constant permeability u, the inductance L for any length will decrease as the radius of the inner conductor (d) approaches the same size as the radius of the outer conductor (D) (i.e., as the distance or separation between d and D is minimized). Thus, for situations where frequency is not an issue (e.g., direct current (DC)), increasing the size of the center pins 204, 202 and the corresponding jacks 520, 220, and electrical connection 552, to carry more current, also help to reduce the gap size between the supply and the return paths, reducing the inductance and making such embodiments suitable for power transmission.

As those of skill in the art appreciate, many higher frequency applications (e.g., RF, microwave) require connectors and cables to be impedance matched to standard values (e.g., 50Ω, 75Ω, etc.) and this can impose limitations on the spacing between inner and outer conductors, as well as limitations on the diameter of inner and outer conductors. The characteristic impedance of a transmission line is equal to the square root of the ratio of the line's inductance per unit length divided by the line's capacitance per unit length. Thus, to provide requisite impedance matching in some applications, the inductance per unit length (e.g., as computed in equation (1) above) may have some limitations on the ratio of outer conductor to inner conductor. These limitations are not required if impedance matching is not a concern, as in DC operations. Thus, the advantageous features and configuration of bullet connectors and board connectors that are used in RF types of circuits, can be modified and adapted, as described herein, to provide advantages in DC circuits, including providing new approaches for carrying DC power with large pulsing currents and additional compliant features to enable more tolerance of misalignments. In addition, the lack of RF design constraints allows for additional axial engagement variation over existing RF bullet designs, as discussed further herein.

As shown in FIGS. 2-5, the power bullet 114 includes a compliant outer conductor portion corresponding to shell 244, and each of the first CCA connector 112 and second CCA connector 110 include a respective compliant center pin 204, 202. In certain embodiments, the pluralities of body spring fingers 404, 504 may be formed of compliant materials, such as Beryllium Copper (BeCu) and stainless steel (e.g., a corrosion-resistant alloy of iron, chromium and, in some cases, nickel and other metals). The compliant outer conductor portion 244 is formed at least in part via the pluralities of body spring fingers 404, 504, which together help to form the locking edges 604, 606, which are configured to cooperate with the smooth bore portion 111 on the second CCA connector 110 and the stepped detent 117 of the full detent portion 113 on the first CCA connector 112. The pluralities of body spring fingers 405, 504 are also configured to deflect upon insertion into the respective first CCA connector 112 and second CCA connector 110. As discussed herein, the overall interconnect 116 (formed when the first CCA connector 112 is assembled to the second CCA connector 110 via the power bullet 114) is substantially compliant and has an improved mating tolerance range as compared to known interconnects used for transmitting DC power.

The interface between the full detent portion 113 and the power bullet 114 helps to retain the power bullet 114, yet allows a degree of radial misalignment, whereas the interface between the smooth bore portion 111 and the power bullet 114 can be configured to allow a degree of misalignment in both radial and axial orientations. Being able to tolerate misalignment can be important in arrangements such as that shown in FIG. 1A, where there is a plurality of interconnects 116. As will be appreciated, there can be a mechanical tolerance stack-up when there are a plurality of interconnects in use, such that it can be difficult, time consuming, and costly to provide multiple tight tolerance interconnects and to align them simultaneously and precisely during assembly. Thus, having interconnects with more tolerance to misalignment can be advantageous and economical.

As used herein, axial misalignment refers to at least to an offset distance between a reference plane of the shroud (e.g., shroud 234) and a reference plane of the power bullet 114. As used herein, radial misalignment refers to a distance between centerlines of the mated first CCA connector 112 and second CCA connector 110. Connectors such as bullets have been used in certain types of environments, such as radio-frequency (RF) environments, to help make blindmate connections between circuit boards. In some instances, blindmate connections in the RF environments may have some degree of compliance, e.g., up to around 20 mils of compliance. However, as is understood in the art, RF design constraints and requirements (e.g., impedance matching) can limit the amount of axial engagement variation beyond this deviation. This, in turn, can impact the types of bullet designs as well as the possible applications for their use.

In contrast, in the embodiments herein, the interconnect arrangements are implemented using a power bullet 114 that carries direct current (DC) current, including large pulsing currents, where the power bullet 114 includes compliant spring fingers for both its center jacks (e.g., jacks 520, 220) and its outer shell 244 (e.g., the pluralities of body spring fingers 504, 404), where the pluralities of compliant body and center pin spring fingers help to maintain operable electrical and mechanical communication even during at least one of radial and axial misalignment, while allowing significantly more misalignment than in RF environments. For example, in some embodiments, the interconnect 116 can allow two to three times the degree of misalignment as compared to connectors that are configured in accordance with RF and/or high frequency design constraints; e.g., at least some embodiments of the interconnect 116 allow 40 to 60 mils of misalignment, as compared to only 20 mils of misalignment with connectors configured in accordance with RF and/or high frequency design constraints. The power bullet 114 is configured to be operably coupled to and in operable communication with circuit board connectors (e.g., CCA connectors 110 and 112) that also are configured to compensate for at least one of radial and axial misalignment, such as by including compliant center pins 204, 202. Advantageously, as noted previously, the power bullet 114 and CCA connectors 110, 112, when coupled to form the interconnect 116, can be optimized for applications (e.g., power transmission of DC power) that are not subject to RF or other high frequency design constraints, such as impedance matching. Thus, embodiments of the interconnect 116, as discussed herein, can include modifications not seen in known RF bullets and interconnects, including modifications to the size and spacing of inner and outer conductors, extra spacing and tolerance in jacks for the center pins, and additional insulation (as described herein) that enables the overall interconnect 116 to carry larger amounts of current and to tolerate more types of misalignment. At least some of the embodiments herein take advantage of this option.

For example, as shown in FIGS. 2-5 herein and as further discussed herein, the smooth bore portion 111 is designed to be able to help absorb more axial variations when the power bullet 114 is inserted into it, in terms of “how far” the center pin 202, 204 goes into the corresponding opening on the power bullet 114. In addition, the full detent portion 113, in certain embodiments, is configured to not take advantage of an allowed displacement, so that the full detent side of the interconnect 116 holds onto and retains the power bullet 114. Each of the pluralities of center pin spring fingers 502, 402, grips the respective center pin 204, 202 and helps provide the necessary contact resistance. In addition, as FIGS. 2-5 illustrate, the size (length) of the openings on the first and second jacks 220, 530, respectively is configured to be longer than the length of the portion of the center pins 202, 204 that go in, to allow for more variation in axial alignment while still making electrical and mechanical contact. As will be appreciated, more variation in axial alignment might be resolvable with additional length of the openings (to help compensate for misalignment angle issues). However, the longer the interface between the center pin and spring fingers is, the more voltage drop or loss might result, which can have impact on other parts of a system, as will be appreciated. The additional length in some embodiments proposed herein can be seen, for example, in FIG. 3 and FIG. 5.

For example, in FIG. 3, it can be seen that the first center pin 204 projects into the first jack 520 of the power bullet 114 to a distance that leaves a first tolerance range 505. Similarly, in FIG. 5, it can be seen that the second center pin 202 projects into the second jack 220 of the bullet 115 to a distance that leaves a second tolerance range 205. The first tolerance range 505 and second tolerance range 205 help to ensure that the first jack 520 and second jack 220, respectively, are able to make contact with respective center pins 204, 202 that may vary in how far they project into the respective jack during assembly and during operation. For example, as shown in FIG. 5, the distance that the second center pin 202 projects into second jack 220 is slightly less than the distance that the first center pin 204 projects into first jack 520, which can be illustrative of a possible slight misalignment, in contrast to the illustration in the embodiment of FIG. 4, which shows the first center pin 204 and second center pin each projecting substantially the same distance into their corresponding first jack 520 and second jack 220. In implementations that are carrying DC signals, the depth of each side of each compliant interface can be increased to increase the axial misalignment, as shown in FIG. 5. The gap can increase, in accordance with the embodiments herein. Thus, compliance can increase to whatever is needed. In addition, the pluralities of compliant spring fingers of both the jacks 220, 520 and the outer shell 244, further help to ensure mechanical and electrical connections during misalignment; this is discussed further herein in connection with FIGS. 10-12.

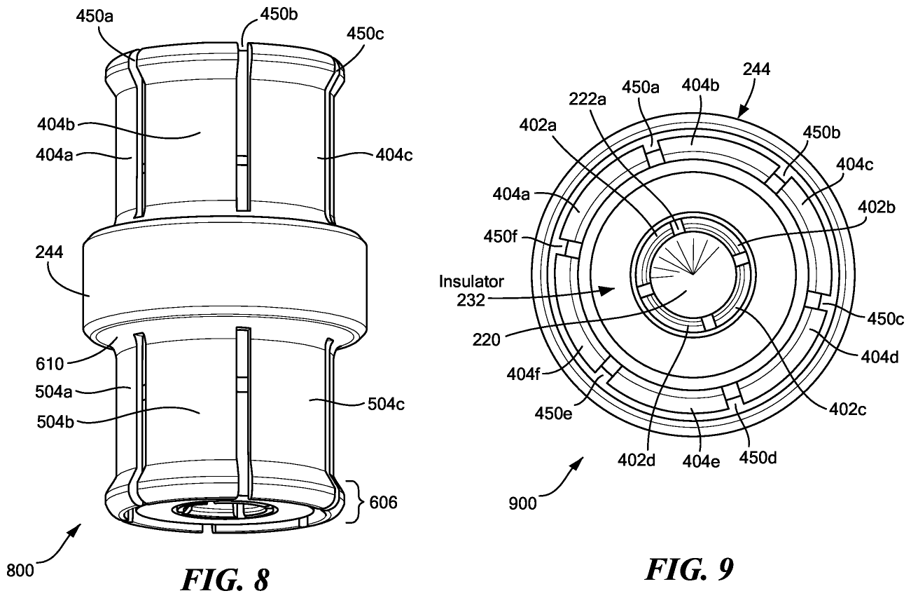

FIGS. 6-9 provide some additional views of an embodiment of the power bullet 114. FIG. 6 is a side view 600 of the power bullet 114 of the interconnect of FIG. 3, in accordance with one embodiment, and FIG. 7 is a perspective view 700 of the power bullet 114 of FIG. 6, showing some details of a first end of the power bullet 114, in accordance with one embodiment. FIG. 8 is a side perspective view 800 of the power bullet 114 of the interconnect of FIG. 6, showing some details of a second end of the power bullet 114, in accordance with one embodiment. FIG. 9 is a view 900 from the first end of the power bullet 114 of FIG. 6, in accordance with one embodiment.

Referring to FIGS. 6-9, it can be seen that there are pluralities of spring fingers on each end of the power bullet 114, for both the outer shell 244 and for each jack 520, 220 used to receive the respective center pins 204, 202 of the first CCA connector 112 and the second CCA connector 110. and the center pin. For example, FIGS. 7 and 9 show that the plurality of second end body spring fingers 404 includes six second end body spring fingers on the second end of the power bullet 114; similarly, the plurality of first end body spring spring fingers 504 includes six body spring fingers on the first end, though only three first end body spring fingers 504a, 504b, 504c, are visible in FIG. 7 (the number of spring fingers shown is illustrative and not limiting). As shown in FIGS. 6-9, the pluralities of body spring fingers 504, 404 at each end are separated by respective pluralities of narrow outer channels or outer slots 550, 450 (e.g., outer slots, 450a, 450b at the second end and outer slots 550a, 550b at the first end). The pluralities of outer slots 550, 450 help to permit individual compliant body spring fingers to move substantially independently of the other body spring fingers, as will be appreciated. This is also true for the plurality of inner slots 451 that are between the pluralities of center pin spring fingers 502, 402, as will be understood. In various embodiments, the number of the plurality of outer slots 450 and the plurality of inner slots 451, as well as the respective lengths of the plurality of outer slots 450 and plurality of inner slots 451 can be varied such that, if the length of an individual one of the plurality of outer slots 450 or an individual one of the plurality of inner slots 451 increases, the result is less contact resistance, since there will be more points of contact. However, if the length of any one or more of the plurality of outer slots 450 and/or the plurality of inner slots 451 is increased, it may be necessary to increase the thickness of one or more the associated adjacent respective center pin and/or body spring fingers (for either the center pin or body), which in certain embodiments act as cantilevered beams, to ensure there is a minimum force to get the desired contact resistance. As will be appreciated, however, as the thickness of center pin and/or body spring fingers increases, the increased thickness effectively limits how much the center pin and/or body spring fingers can plastically deform, thus reducing the amount of deflection the center pin and/or body spring fingers can allow. Those of skill in the art will appreciate that embodiments will have a balance between length and thickness of center pin and/or body spring fingers, depending on the requirements of the specific interface. In addition, as FIG. 6 illustrates, the third dielectric layer 232 of insulator material, is visible between the pluralities of outer slots 450, 550, but this is simply illustrative and not limiting.

The shell 244 of the power bullet 114 includes a central flat portion 245 that is formed integrally with a first tapered ridge 632 and a second tapered ridge 612. Adjacent to each tapered ridge 632, 612 are a first curved portion 630 and second curved portion 610. The pluralities of outer slots 550, 450, for the pluralities of respective body spring fingers 504, 404, run from the respective curved portions 630, 610 to the respective first and second ends of the power bullet 114. As shown in FIGS. 6-9, the power bullet 114 includes pluralities of body spring fingers 504, 404 at each end that each include six respective body spring fingers at each end and a plurality of second end center pin spring fingers 402 that includes four center pin spring fingers(the plurality of first end center pin spring fingers 502 are not visible in FIGS. 6-7), but the number and shape of the plurality of body spring fingers and the plurality of center pin spring fingers, is not limiting.

Each respective body spring finger in the pluralities of body spring fingers 504, 404 terminates in a series of edges that together form a locking edge that is configured to engage, individually (for the given spring finger) as well as collectively (with the other spring fingers serving the same purpose) with at least a portion of other connectors, such as the full detent style first CCA connector 112 or the smooth bore style second CCA connector 110, as well as to multiple other types of connectors, as will be appreciated. For example, the individual first end body spring fingers 504a, 504b, 504c terminate in a first locking edge 604 and the individual second end body spring fingers 404a, 404b, 404c terminate in a second locking edge 606. The locking edge shape shown in FIG. 6 is illustrative and not limiting; the size and thickness of the locking edge can vary depending on the connectors to which the power bullet 114 is being connected. The pluralities of body spring fingers 504, 404, also are configured to be compliant and resilient enough to engage with at least a portion of the respective CCA connectors 110, 112, even during misalignment.

FIG. 10 is a cross section view 1000 of an example interconnect similar to that of FIGS. 2-9, showing further details of the structure and directions of current flow, in accordance with one embodiment, and FIG. 11 is a cross section view 1100 showing further details of one region in the cross-section view of FIG. 10, in accordance with one embodiment. Note that, in FIGS. 10 and 11, the full detent type of third CCA connector 110′ is on the top of the figure, and the smooth bore fourth CCA connector 112′ is on the “bottom,” in the figure, which is opposite to the arrangement of FIGS. 2-5.

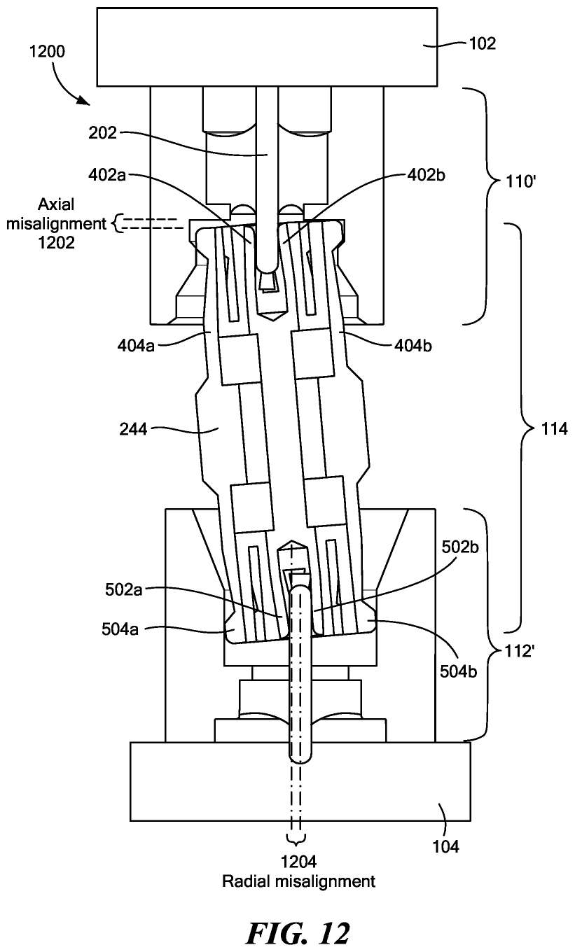

As FIGS. 10-11 show, the positive current 1002 flows from center pins 202 of third CCA connector 110′, through the power bullet 114, to the center pin 204 of the fourth CCA connector 112′. The return current 1004 flows along the outside of the power bullet 114 (i.e., along the shell 244). Note that, positive current 1006 can be carried on either the inner conductor of the power bullet 114 (e.g., from the plurality of center pin spring fingers along the electrical connection 552) or on the outer conductor (e.g., along the shell 244 including along the plurality of body spring fingers), with the return current being carried on the other conductor, while minimizing loop area between the inner conductor and outer conductor, for low inductance, as discussed elsewhere herein. As shown in greater detail in the views of FIGS. 10-12 (FIG. 12 is discussed further below), the first end first center pin spring finger 502a and first end second center pin spring finger 502b are each compliant and are each configured to deflect to help hold first center pin 204 in place, to make electrical and mechanical contact with the first center pin 204, from third CCA connector 110′, through the power bullet 114, to the fourth CCA connector 112′. Note that, the plurality of center pin spring fingers 502 have a nominal position that is designed to grip, so the plurality of center pin spring fingers 502 “deflect” outward when a pin (e.g., center pin 202) is inserted between them.

As an example of showing how engagement happens even during misalignment, reference is made now to FIG. 12, which is a cross section view 1200 showing an illustration of how the interconnect of any of FIGS. 1-11 continues to maintain operable electrical contacts during misalignment, in accordance with one embodiment. Note that FIG. 12 (like FIGS. 10-11) shows a configuration where the CCA connector that is coupled to second CCA 102 is actually a full detent type of third CCA connector 110′ (“third CCA connector 110′”), and the CCA connector that is coupled to the bottom first CCA 104 is actually a smooth bore CCA connector 112′ (“fourth CCA connector 112′”), which is opposite to the arrangement illustrated in FIGS. 2-5, but this does not impact the features being depicted.

FIG. 12 illustrates a condition wherein the fourth CCA connector 112′ is not in alignment with the third CCA connector 110′, such that the first center pin 204 is not along the same axis as the second center pin 202. As a result, the power bullet 114 is at an angle relative to the vertical, as shown in FIG. 12. For example, there is axial misalignment 1202 at the top near where the second end body spring fingers 404a, 404b are making contact with the third CCA connector 110′ (there is also axial misalignment at the bottom where the first end body spring fingers 504a, 504b make contact with fourth CCA connector 112′, but for clarity only one of the axial misalignments is discussed here). As FIG. 12 shows, the compliant feature of second end body spring fingers 404a, 404b enable the second end body spring fingers 404a, 404b, to still make sufficient electrical and mechanical contact with the CCA connector 110 even with the axial misalignment 1202.

Still referring to FIG. 12, it also can be seen that both the individual second end center pin spring fingers 402a, 402b and the first end center pin spring fingers 502a, 502b, stay in contact with, respectively, the second center pin 202 and first center pin 204, even with radial misalignment 1204. In particular, it can be seen that the center pin spring fingers 502a, 501b are deformed inward along the plurality of slots 450, thus creating a smaller diameter hole for the second center pin 202 to slide within. The radial deflection of each of the center pin spring fingers 502 may be such that it is less than the diameter of the center pin 204 locally, and this helps to retain all points of contact between the center pin spring fingers 502 and the center pin 204. Several mechanical features of the interconnect 116 enable this to happen.

First, using the pluralities of compliant center pin spring fingers 502, 402, as part of the jacks 520, 220 of the power bullet 114 means that the interface between the respective jack 520. 220 and the respective center pins 204, 202, will have a flexibility, thereby enabling the pluralities of center pin spring fingers 502, 402, to maintain contact with the center pin even when the associated CCA connector or the power bullet has some movement (e.g., vibration or shock) during operation or misalignment during assembly.

Second, the jacks 520, 220 are longer/deeper than other jacks used in other types of connectors, not just to accommodate the longer and thicker center pins 204, 202 but also to provide more room for misalignment and internal conductive area for the center pins 204, 202 to contact.

Third, the outer shell 244 of the power bullet 114 has the pluralities of compliant body spring fingers 504, 404 that are configured to retain electrical and mechanical contact when inserted into the respective CCA connectors 110, 112, be they smooth bore or full detent type.

The above-described embodiments can have many applications beyond those described herein. At least some advantageous applications may include moving high current between a circuit card assembly stack-up in a limited volume. Another application may include transporting high current, low inductance power forms using a single connector, in a constrained volume. The low inductance feature of at least some embodiments herein, can allow for a reduction in bulk capacitance downstream, reducing system weight and conserving board space.

It should be understood, however, that the disclosed embodiments are not limited to use with the above-listed exemplary devices, systems, and arrangements. The embodiments described herein have numerous applications and are not limited to the exemplary applications described herein. It should be appreciated that such references and examples are made in an effort to promote clarity in the description of the concepts disclosed herein. Such references are not intended as, and should not be construed as, limiting the use or application of the concepts, systems, arrangements, and techniques described herein to use solely with these or any other systems.

For purposes of illustrating the present embodiments, the disclosed embodiments are described as embodied in a specific configuration and using special logical arrangements, but one skilled in the art will appreciate that the device is not limited to the specific configuration but rather only by the claims included with this specification. In addition, it is expected that during the life of a patent maturing from this application, many relevant technologies will be developed, and the scopes of the corresponding terms are intended to include all such new technologies a priori.

The terms “comprises,” “comprising”, “includes”, “including”, “having” and their conjugates at least mean “including but not limited to”. As used herein, the singular form “a,” “an” and “the” includes plural references unless the context clearly dictates otherwise. Various elements, which are described in the context of a single embodiment, may also be provided separately or in any suitable subcombination. It will be further understood that various changes in the details, materials, and arrangements of the parts that have been described and illustrated herein may be made by those skilled in the art without departing from the scope of the following claims.

Throughout the present disclosure, absent a clear indication to the contrary from the context, it should be understood individual elements as described may be singular or plural in number. For example, the terms “circuit” and “circuitry” may include either a single component or a plurality of components, which are either active and/or passive and are connected or otherwise coupled together to provide the described function. Additionally, the term “signal” may refer to one or more currents, one or more voltages, and/or a data signal. Within the drawings, like or related elements have like or related alpha, numeric or alphanumeric designators. Further, while the disclosed embodiments have been discussed in the context of implementations using discrete components, including some components that include one or more integrated circuit chips), the functions of any component or circuit may alternatively be implemented using one or more appropriately programmed processors, depending upon the signal frequencies or data rates to be processed and/or the functions being accomplished.

Similarly, in addition, in the Figures of this application, in some instances, a plurality of system elements may be shown as illustrative of a particular system element, and a single system element or may be shown as illustrative of a plurality of particular system elements. It should be understood that showing a plurality of a particular element is not intended to imply that a system or method implemented in accordance with the disclosure must comprise more than one of that element, nor is it intended by illustrating a single element that the disclosure is limited to embodiments having only a single one of that respective elements. In addition, the total number of elements shown for a particular system element is not intended to be limiting; those skilled in the art can recognize that the number of a particular system element can, in some instances, be selected to accommodate the particular user needs.

In describing and illustrating the embodiments herein, in the text and in the figures, specific terminology (e.g., language, phrases, product brands names, etc.) may be used for the sake of clarity. These names are provided by way of example only and are not limiting. The embodiments described herein are not limited to the specific terminology so selected, and each specific term at least includes all grammatical, literal, scientific, technical, and functional equivalents, as well as anything else that operates in a similar manner to accomplish a similar purpose. Furthermore, in the illustrations, Figures, and text, specific names may be given to specific features, elements, circuits, modules, tables, software modules, systems, etc. Such terminology used herein, however, is for the purpose of description and not limitation.

Although the embodiments included herein have been described and pictured in an advantageous form with a certain degree of particularity, it is understood that the present disclosure has been made only by way of example, and that numerous changes in the details of construction and combination and arrangement of parts may be made without departing from the spirit and scope of the described embodiments. Having described and illustrated at least some the principles of the technology with reference to specific implementations, it will be recognized that the technology and embodiments described herein can be implemented in many other, different, forms, and in many different environments. The technology and embodiments disclosed herein can be used in combination with other technologies. In addition, all publications and references cited herein are expressly incorporated herein by reference in their entirety.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the following claims.

What is claimed is:

1. An interconnect, comprising:
a first connector comprising a first compliant center pin and a first shroud, wherein the first compliant center pin comprises an electrically conductive material and wherein the first shroud is configured with a first connector detent feature;
a second connector comprising a second compliant center pin and a second shroud, wherein the second compliant center pin comprises an electrically conductive material and wherein the second shroud is configured with a smooth bore feature; and
a bullet connector configured to be electrically and mechanically coupled to the first and second connectors, the bullet connector comprising a first end, second end, inner conductor, insulator layer, and outer conductor, wherein:
the inner conductor further comprises a first compliant jack disposed proximate to the first end and electrically coupled to a second compliant jack disposed proximate to the second end;
the first compliant jack comprises a plurality of first center pin spring fingers configured to engage the first compliant center pin;
the second compliant jack comprises a plurality of second center pin spring fingers configured to engage the second compliant center pin;
the outer conductor is spaced apart from the inner conductor by a predetermined gap and is configured to engage electrically and mechanically with the first and second shrouds, wherein the outer conductor extends from the first end to the second end, wherein a first section of the outer conductor that is proximate to the first end, is formed from a plurality of first body spring fingers and wherein a second section of the outer conductor that is proximate to the second end is formed from a plurality of second body spring fingers, wherein the plurality of first body spring fingers and the plurality of second body spring fingers are configured to engage, respectively, with the first shroud and the second shrouds; and
the insulator layer, comprises an electrically insulating material disposed in between the inner conductor and the outer conductor and is configured to electrically isolate the inner conductor from the outer conductor, wherein the insulator layer is configured to be concentric with the inner conductor and outer conductor.

2. The interconnect of claim 1, wherein the predetermined gap between the inner conductor and outer conductor has a size selected to minimize an inductance of the interconnect.

3. The interconnect of claim 1, wherein the inner conductor and outer conductor each have a size suitable for carrying high levels of direct current (DC).

4. The interconnect of claim 1, wherein a size of at least one of the first compliant jack and second compliant jack is selected to maximize allowable misalignment.

5. The interconnect of claim 1, wherein at least one spring finger of the plurality of first center pin spring fingers of the first compliant jack and the plurality of second center pin spring fingers of the second compliant jack, is configured to deflect to maintain electrical connection to a respective compliant center pin inserted into a respective compliant jack, under a condition where the first connector is not aligned to the second connector.

6. The interconnect of claim 5, wherein the at least one spring finger that is configured to deflect, deflects by an amount that is less than a diameter of the compliant center pin inserted within the respective compliant jack, wherein an amount of the deflection of the at least one spring finger is configured to enable retention of at least a majority of a set of points of contact between the spring fingers and the compliant center pin.

7. The interconnect of claim 1, wherein at least one of the plurality of first body spring fingers and second body spring fingers, is configured to deflect, when a respective compliant center pin is inserted into a respective compliant jack, to maintain electrical connection to the respective shroud of the respective first or second connector whose compliant center pin is inserted into the respective compliant jack.

8. The interconnect of claim 1, wherein at least one of the first and second compliant center pins is configured to compensate for at least one of radial and axial misalignment between the first connector and the second connector, when the first connector and second connector are operably coupled to the bullet connector.

9. The interconnect of claim 1, wherein the plurality of first body spring fingers are configured to form a spring finger detent feature configured to engage with the first connector detent feature.

10. The interconnect of claim 9, wherein an interface between the spring finger detent feature and the first connector detent feature is configured to allow a predetermined amount of radial misalignment between the first connector and the bullet connector, while still ensuring that the spring finger detent feature is engaged with the first connector detent feature.

11. The interconnect of claim 1, wherein the plurality of second body spring fingers are configured to engage with the smooth bore feature.

12. The interconnect of claim 11, wherein an interface between the plurality of second body spring fingers and the smooth bore detent feature is configured to allow a predetermined amount of at least one of axial and radial misalignment between the second connector and the bullet connector, while still ensuring that the plurality of second body spring fingers is engaged with the smooth bore feature.

13. A bullet connector configured to interconnect first and second connectors, the bullet connector comprising:
a first end having a first compliant jack configured for engaging a first center pin of a first connector, wherein the first compliant jack comprises a plurality of first center pin spring fingers configured to engage the first center pin;
a second end having a second compliant jack configured for engaging a second center pin of a second connector, wherein the second compliant jack comprises a plurality of second center pin spring fingers configured to engage the second center pin;
an inner conductor configured to electrically couple the first compliant jack to the second compliant jack;
an outer conductor spaced apart from the inner conductor by a predetermined gap and configured to engage electrically and mechanically with a first shroud of the first connector and a second shroud of the second connector, wherein the outer conductor extends from the first end to the second end, wherein a first section of the outer conductor that is proximate to the first end, is formed from a plurality of first body spring fingers and wherein a second section of the outer conductor that is proximate to the second end is formed from a plurality of second body spring fingers, wherein the plurality of first body spring fingers and the plurality of second body spring fingers are configured to engage, respectively, with the first shroud and the second shroud; and
an insulator layer, comprising an electrically insulating material disposed in between the inner conductor and the outer conductor and is configured to electrically isolate the inner conductor from the outer conductor, wherein the insulator layer is configured to be concentric with the inner conductor and outer conductor.

14. The bullet connector of claim 13, wherein the predetermined gap between the inner conductor and outer conductor has a size selected to minimize an inductance of the bullet connector.

15. The bullet connector of claim 13, wherein a size of at least one of the first and second compliant jacks is selected to maximize allowable misalignment.

16. The bullet connector of claim 13, wherein the inner conductor and outer conductor each have a size suitable for carrying high levels of direct current (DC).

17. The bullet connector of claim 13, wherein at least one spring finger of the plurality of first center pin spring fingers of the first compliant jack and the plurality of second center pin spring fingers of the second compliant jack, is configured to deflect to maintain electrical connection to a respective compliant center pin inserted into the respective compliant jack, under a condition where the first connector is not aligned to the second connector.

18. The bullet connector of claim 17, wherein the at least one spring finger that is configured to deflect, deflects by an amount that is less than a diameter of a center pin inserted within the respective compliant jack, wherein an amount of the deflection of the at least one spring finger is configured to enable retention of at least a majority of a set of points of contact between the spring fingers and the center pin.

19. The bullet connector of claim 13, wherein at least one of the plurality of first body spring fingers and second body spring fingers, is configured to deflect, when a center pin is inserted into the respective compliant jack, to maintain electrical connection to a respective shroud of a connector whose center pin is inserted into the respective compliant jack.

20. The bullet connector of claim 13, wherein the plurality of first body spring fingers are configured to form a spring finger detent feature configured to engage with a detent feature of a connector to which the bullet is operably coupled.
